(19) United States
(12) Patent Application Publication
(10) Pub. No.: US 2010/0300069 A1
(43) Pub. Date: Dec. 2, 2010

(54) CONTROL OF A MOTOR VEHICLE INTERNAL COMBUSTION ENGINE

(75) Inventors: Olaf Erik Herrmann, Moenchengladbach (DE); Schnorbus Thorsten, Aachen (DE); Matthias Lamping, Aachen (DE); Ludger Ruhkamp, Kerpen (DE)

Correspondence Address: GIFFORD, KRASS, SPRINKLE,ANDERSON & CITKOWSKI, P.C, PO BOX 7021, TROY, MI, 48007-7021, US

(73) Assignee: FEV MOTORENTECHNIK GMBH, Aachen (DE)

(21) Appl. No.: 12/597,579

(22) PCT Filed: Apr. 26, 2007
(86) PCT No.: PCT/EP07/03683

§ 371 Date: Dec. 2, 2009

(51) Int. Cl. F02D 43/00; F02D 41/00

(52) U.S. Cl. 60/274; 60/289

(57) ABSTRACT

The present invention relates to a method for operating a motor vehicle internal combustion engine having a controller for adjusting NOx emissions in the exhaust gas, wherein a NOx controller is combined with a combustion controller. A control unit of an internal combustion engine is further proposed, said control unit comprising first control means for performing cylinder pressure-based combustion control, and second control means for performing NOx control, wherein the first and second control means are linked to each other.

### CROSS-REFERENCE TO RELATED APPLICATIONS

This application is the U.S. national phase of international patent application PCT/EP2007/003683 filed Apr. 26, 2007.

### FIELD OF THE INVENTION

The present invention relates to a method for operating a motor vehicle internal combustion engine with a control method for minimizing NOx emissions in the exhaust gas and also a control unit of an internal combustion engine itself.

### BACKGROUND OF THE INVENTION

For compliance with future emission values, nitrogen oxide emissions will become more and more important. In the case of internal combustion engines in use today, especially in motor vehicles, it is often provided that a fresh-air mass flow is regulated, in order, in this way, to achieve controlled combustion under consideration of NOx emissions. In principle, deviations occur in the case of such control methods due to variance in mass production in the region of the air system and also the sensors, but also due to component aging. These deviations can have a considerable influence, especially on the emission behavior of nitrogen oxides.

### SUMMARY OF THE INVENTION

The problem of the present invention is to provide a control method by means of which strict, long-term requirements on NOx emissions can be satisfied. This problem is satisfied with a method and control unit as disclosed herein. Additional advantageous implementations and refinements are specified in the corresponding claims.

A method for operating a motor vehicle internal combustion engine is proposed with a control method for adjusting NOx emissions in the exhaust gas, wherein an NOx control method is performed combined with a combustion control method. The advantage of an NOx control method is that, in principle, this is less susceptible with respect to variance in mass production than a previously common air mass control method. Through a combination of the NOx control method with a combustion control method, an increase in stability over the service life is achieved. Simultaneously, this allows additional minimization in the scope of a calibration of determined intervals to be set, in particular, legally set maximum values for NOx emissions.

According to one embodiment it is provided that the NOx control method of the combustion control method forces an NOx value to be observed. In particular, it is provided that the NOx control method of the combustion control method forces a desired value, in particular, an NOx-dependent parameter, It could also be provided that the NOx control method of the combustion control method forces a limiting value. This limiting value could be, in particular, an NOx value that may not be exceeded in the scope of the combustion control method. The combustion control method is performed, in turn, preferably as a cylinder pressure-based combustion control method. One possibility for performing such a combustion control method emerges from DE 10 2006 015503 which is incorporated by reference in its entirety into the scope of this disclosure. Another embodiment of a combustion control method, in particular, a cylinder pressure-based combustion control method emerges from DE 10 2007 013119 which is incorporated by reference in its entirety into the scope of this disclosure. In this way, the combustion control method can selectively influence the NOx emissions, in particular, through adaptation of the combustion center point.

The use of a model preferably allows advance calculation of how an NOx-related value would change with a change in a combustion control method. Here, an NOx control method forces, for example, a desired value for the combustion control method. Therefore, which change comes closest to the desired NOx value with respect to the combustion control method can be considered in relation to a model. Based on this estimation, the combustion control method is then adjusted. Here, for example, injection is adjusted toward an advanced position, preferably, a shift of the center point of combustion toward an advanced position not as far as would be possible. Instead, the primary compliance of the NOx value, for example, in the form of allocation-corresponding factors or a corresponding weighting in the scope of the control could be realized while accepting somewhat worse fuel consumption. For example, if it recognized in the scope of the model calculation that a desired NOx value cannot be achieved, then an NOx value can be set as a target, which, in turn, is selected in consideration with combustion advantages with respect to fuel.

Preferably, the proposed method is in the position to be able to estimate, through model-based calculation, which effects a change of a combustion center point has on the NOx emissions and allows, with a corresponding correlation, the adjustment of desired NOx values.

One embodiment provides that the NOx control method monitors NOx values in the exhaust gas of the internal combustion engine and correlates them in relation to an NOx limiting value, and the combustion control method performs adjustments for observing the NOx limiting value on the basis of values of the NOx control method. This can result in a change of the combustion center point. However, in the context of combustion control, a different adaptation could also be provided. For example, required adaptation can be performed by changing the injection profile, by changing one or both times of the injection start or end, by advanced and/or retarded injection or multiple injection.

According to one embodiment, it is provided that one value originating from a real NOx sensor is compared with a value originating from a virtual NOx sensor. For this purpose, in particular, an NOx model and/or an adaptive exhaust-gas recirculation control method can be used from PCT/EP2007/003686, which is incorporated by reference in its entirety into the scope of the disclosure of this invention including the virtual NOx sensor and also the presented adaptive AGR model and also NOx model.

In addition, a learning function can be integrated into the method. For example, it is provided that the learning function receives a parameter from a link with a value determined by an NOx sensor and a value determined by a virtual NOx sensor, wherein the learning function allows the parameters to be input into an NOx model from which the control method is provided with a virtual NOx signal.

It has proven advantageous that at least one of the virtual or actual determined values of rail pressure, injection characteristics, preferably injection beginning, combustion characteristics, preferably a combustion point, and/or injection quantity is used as a control parameter, especially for the cylinder pressure-based combustion control. From DE 10 2007 013119, which is herein incorporated by reference, different definitions emerge as to what is to be understood under the parameters named above with respect to cylinder pressure-based combustion profile control. These virtual determined values can be used by the control method especially without distortion with respect to dynamic processing of actual and virtual parameters. The use of virtual values in the scope of the control allows a time delay to be compensated as could otherwise be generated based on the actual values by the lambda probe and also by the NOx probe. While it is assumed that the lambda probe transmits its information with a time delay of approximately 300 ms, in the case of the NOx probe, a time delay of approximately 700 ms is to be expected. Through the use of virtual values in the scope of modules determined by models, at least in terms of presetting control, but especially by a cascade control, the necessary values can be set in advance, especially presetting with respect to an NOx value or an injection or a medium pressure to be set or a combustion point in the cylinder. For example, it is provided according to one implementation that an air-path control method sets an NOx value, wherein a combustion control method of the air-path control method transmits a signal for changing the NOx value if a set point, especially a limiting value, is exceeded. Through the additional use of virtual determined values, the response can be performed in advance of the overshoot. Through a simultaneous adaptation, especially adaptation in the scope of an adapted control method and especially through the use of the learning function, the existing virtual determined values are correlated with the values actually recorded by the lambda probe or NOx probe. From this correlation, the correspondingly adapted values are then used further in the control method.

The air-path control method is able to influence, for example, the air mass flow fed to the internal combustion engine, especially also the oxygen flow. For this purpose, for example, an exhaust-gas recirculation rate can be controlled. Pressurization can also be controlled accordingly, for example, by means of a guide vane adjustment of a compressor.

It has proven advantageous that, in the scope of the control, the measurement values of the NOx probe are classified in terms of priority with respect to those of the lambda probe when referencing the lambda probe and the NOx probe for determining measurement values. Here it has been shown that due to the combination of the NOx control with the combustion control, a demand for accuracy on the lambda probe can turn out lower than a demand on the NOx probe. The tolerance field of the lambda probe thus can be wider than that of the NOx probe. Likewise, there is the possibility that the sensitivity or quality of the probes is different, wherein the sensitivity or quality of the lambda probe is less than that of the NOx probe.

One embodiment provides that a comparison of previously set limiting values of an NOx emission of the internal combustion engine can be compared with new calculated limiting values that are determined by means of the method, and, in the case of deviation of the limiting values from each other, the value is selected that is closer to a limiting value set in advance externally. In this way, it is possible that, on the one hand, the limiting value that can be set in advance can be adapted to changing legal regulations. On the other hand, in the scope of the calibration of the system, the limiting value can always be selected, for example, as a desired value that is the best possible with respect to the limiting value that can be set in advance due to the time changing reaction of the system. In this way, in particular, component aging, as can occur in sensors, can also be detected, as well as also variance in the mass production of components, such as, in particular, sensors or components installed into the gas-guiding parts of the internal combustion engine.

In addition, it can be provided that the combination of the NOx control method and combustion control method is integrated into a combined control method of an NOx concentration in the exhaust gas, a combustion air ratio in the exhaust gas, an exhaust-gas temperature, a combustion noise, a combustion function, and a cylinder peak pressure. However, only parts of these could also be controlled in the scope of a combined control method.

Preferably, a cascade control method is used in the control method. For example, it could be provided that the NOx control method is used as an outer cascade and the combustion control method is used as an inner cascade. The combustion control method thus could allow very quick adaptation, while the NOx control method provides a higher-order function due to the somewhat slower behavior of the NOx probe. Another embodiment uses a cascade control method in which the NOx control method is used as an inner cascade and the combustion control method is used as an outer cascade. For example, it is provided that an average pressure, a waste-heat function, and/or a cylinder peak pressure is used as the control parameter.

According to another embodiment of the invention, a control unit of an internal combustion engine is proposed, wherein the control unit has first control means for performing a cylinder pressure-based combustion control method and second control means for performing an NOx control method, wherein the first and second control means are linked to each other. This control unit preferably has a cascade control method made from first and second control means. The first control means has, for example, a combustion control method, and the second control means has an air-efficiency control method, wherein each control method is connected to an NOx probe and a lambda probe, and has a correlation element by means of which a first NOx value made from the combustion control method and a second NOx value from the air-efficiency control method can be linked to each other. An adaptive control method is preferably integrated in the control unit. For example, a virtual NOx sensor is also implemented in the control unit. In addition, an AGR model could also be realized. Preferably, at least one of the cylinders for the combustion control has a pressure sensor, in order to be able to detect a cylinder pressure for the combustion control method. In addition, it could be provided that each cylinder has a corresponding pressure sensor for the combustion control method. With respect to the construction of the combustion control method, the corresponding installed components used for this purpose, as well as sensors, we refer, for example, to the applications of the applicant filed for intellectual property rights and indicated above, which are incorporated in this respect in their entirety in the scope of the disclosure here.

### BRIEF DESCRIPTION OF THE DRAWINGS

Additional advantageous implementations and refinements will be explained in more detail with reference to the figures below. However, the features presented here are not restricted to the implementation shown. Instead, one or more of these features could also be linked to other features from different implementations and also the above description to form new refinements. The presented examples are especially also not to be viewed as restrictive, but instead are used, above all, for more detailed explanation. Shown are:

FIG. 1, a schematic overview of a motor vehicle internal combustion engine, and

FIG. 2, a schematic overview of a combustion sequence under use of an NOx model for the NOx control method.

### DETAILED DESCRIPTION OF THE INVENTION

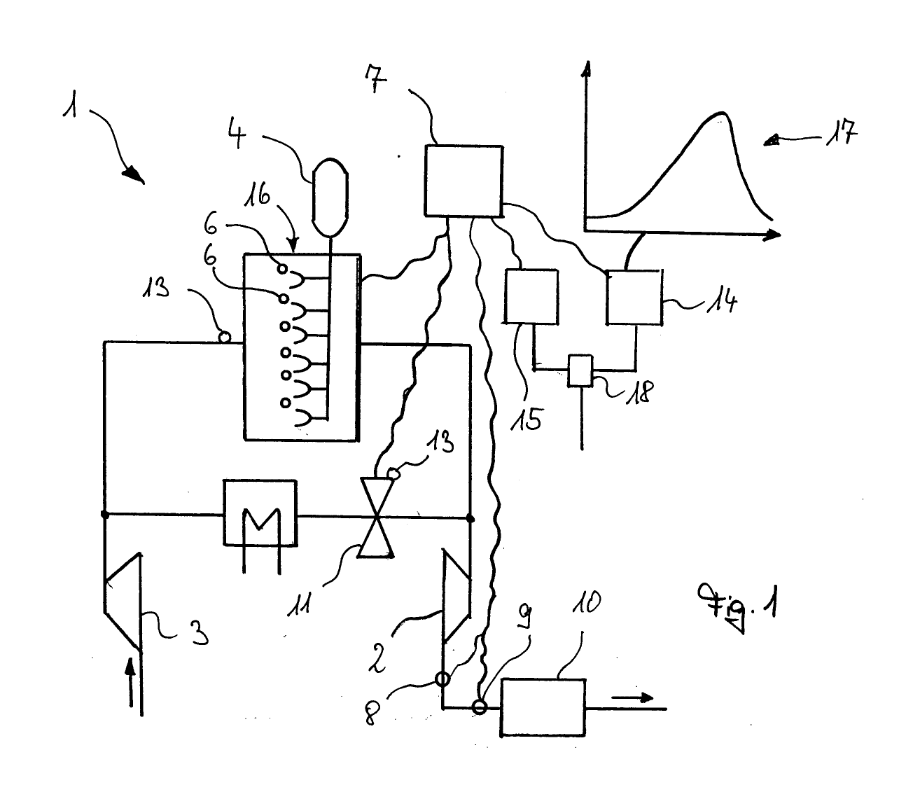

In a schematic view, FIG. 1 shows an internal combustion engine, in particular, a motor vehicle internal combustion engine 1. This can be used in commercial vehicles but also in passenger cars just like the corresponding control method. The motor vehicle internal combustion engine 1 is charged. For this purpose, as an example, a turbine 2 and also a compressor 3 are shown schematically. The motor vehicle internal combustion engine 1 has a common-rail system 4 by means of which each individual cylinder 5 can be supplied with fuel. One sensor 6, in particular, a pressure sensor, is assigned to each cylinder 5. By means of this sensor, in particular, a cylinder pressure-based combustion control method can be performed. A control unit 7 is connected to all of the relevant components, preferably by a bus system or a comparable data-transmitting means. In the exhaust-gas line, an NOx probe 8 and also a lambda probe 9 are arranged downstream of the motor vehicle internal combustion engine. In addition, in the exhaust-gas line there is an exhaust-gas treatment system 10. The exhaust-gas treatment system 10 could be a catalytic converter, a diesel particulate filter, and/or some other device for influencing the exhaust-gas flow. It can have a one-part or two-part construction, and there could also be one or more of such devices. By means of an exhaust-gas recirculation valve 11, there is also the possibility to be able to set an exhaust-gas recirculation rate that is fed to the fresh-air flow from the compressor 3. The exhaust-gas recirculation mass flow is here fed via a cooler 12. The exhaust-gas recirculation mass flow is preferably controlled. Also, additional sensors 13 that are connected, in particular, to the control unit 7 could also be arranged at one or more locations in the system shown schematically. By means of these sensors, for example, temperatures, pressures, and also mass flows could be detected. The control unit 7 preferably has first control means 14 and second control means 15. In the scope of the diagram shown here, these are shown separate from the control unit 7. However, they could also be integrated together. The control unit 7 is preferably integrated into an engine control method. However, there is also the possibility that parts of the control unit 7 are arranged in individual, different control methods that are assigned to corresponding components of the internal combustion engine and its installed components. The control means 14, 15 can include actuators, in particular, for valves, flaps, or other control means. The first control means 14 is in the position to be able to influence, for example, an injector system of the motor vehicle internal combustion engine 1. The injector system 16 is preferably integrated into the motor vehicle internal combustion engine 1. Here, by means of the injector system 16, an injection rate, an injection rate profile, a time of a beginning of an injection, and also an end of an injection, as well as the advance injection and also retarded injection could be adjusted accordingly. In particular, in interaction with the sensors 6, the first control means 14 allows the cylinder pressure-based combustion control method 17 that is shown schematically. The first control means 14 and the second control means 15 are preferably linked to each other, which is indicated schematically, as one example, by a correlation device 18. By means of the correlation device 18, values that are determined by means of the first and second control means 14, 15 can be linked to each other and further used, especially in the scope of the overall control of the control unit 7. If the motor vehicle internal combustion engine 1 is, for example, a motor vehicle internal combustion engine operating according to the diesel principle, an exhaust gas recirculation model, for example, can be stored in the control unit 7. In addition, an air-efficiency model could also be stored there. Through corresponding sensors, a temperature downstream of the motor vehicle internal combustion engine, a value determined by the lambda probe 9, a pressure upstream of the internal combustion engine, and an exhaust gas recirculation flow are transmitted, for example, in the air-efficiency model. From these values, the air-efficiency model calculates, for example, virtual values that are then used in an NOx model. From this, a virtual NOx signal is determined that is then fed directly or after compensation to a preferably PID control method. Compensation can be performed between the virtual NOx signal and an NOx value determined from an engine characteristic map, for example, as a function of a velocity, fuel quality, or some other parameter, such as load. In addition, the control unit 7 can then perform, through the use of the combustion control method 17, an advance setting that finally leads via the NOx control method of the control unit 7 to a minimization of the NOx emissions in the exhaust gas. Below it is described how, for example, an NOx model could be set up for, in particular, a virtual NOx sensor and how, in particular, adaptation also takes place.

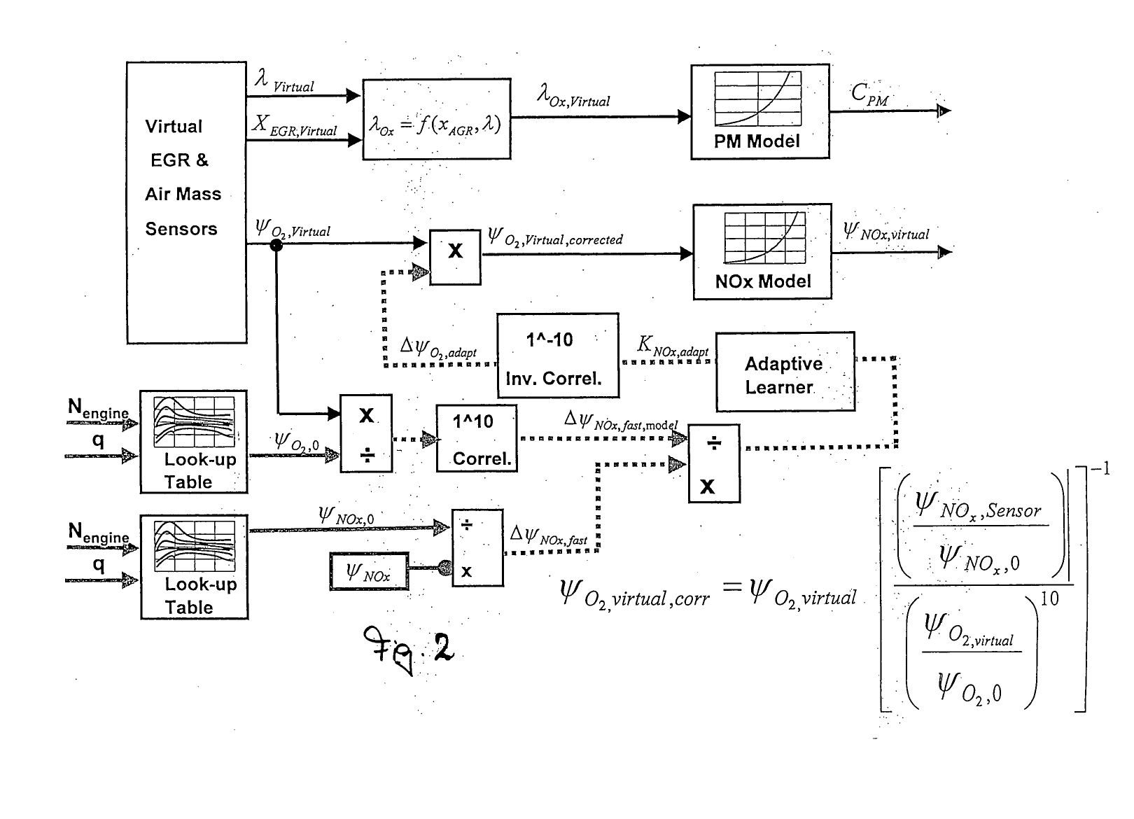

FIG. 2 shows an adaptation of the NOx model by means of the values determined by means of the NOx sensor. The virtual values air efficiency λᵥᵢᵣₜᵤₐₗ, virtual AGR rate X_{EGR virtual}, and the virtual oxygen percentage Ψ_{O2virtual} determined, for example, from FIG. 1, are used to determine a virtual oxidation-air ratio λ_{Ox, virtual}, for example. These are entered into a particulate model. From this, a particulate concentration C_{PM} in the exhaust gas can be determined. From the percentage Ψ_{O2, virtual} of oxygen, under consideration of an adapted oxygen percentage difference, a corrected percentage of oxygen Ψ_{O2, virtual corrected} is fed to an NOx model. From this, a virtual percentage of NOx can then be determined. The formula for determining the virtual corrected oxygen percentage is given here from the relationship taken from FIG. 2. For the virtual oxygen percentage and the engine characteristic map determined by means of a rotational speed N_{engine} and a load q, a desired value of an oxygen percentage is fed. The same is performed for a percentage of NOx as a desired value from an engine characteristic map, wherein this value is also compared with the NOx percentage determined by the NOx sensor. While a difference of the NOx percentage is realized from the comparison of the oxygen percentage by means of a correlation as a model-based, quickly determined value, the comparison of the NOx percentages from the engine characteristic map or from the NOx sensor gives a second difference value. They are compared with each other and then provided to a learning function. From this, an adapted NOx value is now provided to an inverse correlation from which a difference value is then produced for the oxygen percentage in the form of a ΔΨ_{O2} adapter. The correlation that is preferably used here is given from the dissertation OE Herrmann at RWTH Aachen entitled “Emission control for commercial vehicle engines by means of dne air and exhaust-gas path,” especially from Equation 2-3 indicated on page 7. The determined difference value is then entered into the comparison with the virtual determined oxygen percentage and corrects this value. This corrected value is entered into the NOx model, wherein, from this NOx model, the virtual NOx percentage Ψ_{NOx, virtual} can now be determined. The goal here is that the NOx value that is determined by the NOx sensor specifies an actual state description and agrees as much as possible with the value that could be finally determined in this way as the NOx percentage Ψ_{NOx, virtual} by the NOx model. Due to the virtual values that are available more quickly and also the use of the learning function and thus the adaptation, a quicker and especially also a more precise setting of a mass flow can be performed on the exhaust-gas recirculation, in order to be able to maintain the desired nitrogen values or particulate values.

1. A method for operating a motor vehicle internal combustion engine with a control method for setting NOx emissions in the exhaust gas, wherein an NOx control method is performed combined with a combustion control method.

2. The method according to claim 1 wherein the NOx control method of the combustion control method sets in advance an NOx value to be observed.

3. The method according to claim 1, wherein the NOx control method of the combustion control method sets a desired value in advance.

4. The method according to claim 1, wherein the NOx control method of the combustion control method sets a limiting value in advance.

5. The method according to claim 1, wherein a virtual NOx sensor is used, in order to interact with an exhaust-gas recirculation control method.

6. The method according to claim 2, wherein the NOx control method monitors NOx values in the exhaust gas of the internal combustion engine and correlates it to an NOx limiting value and the combustion control method performs an adaptation for maintaining the NOx limiting value on the basis of values of the NOx control method.

7. The method according to claim 1, wherein a value originating from a real NOx sensor is compared with a value originating from a virtual NOx sensor.

8. The method according to one claim 1, wherein a learning function receives a parameter from a link of a value determined by an NOx sensor and a value determined by a virtual NOx sensor, wherein the learning function can influence the parameters in an NOx model from which a virtual NOx signal is provided to the control method.

9. The method according to claim 8, wherein at least one of the virtual determined values of rail pressure, injection characteristics, such as, preferably, injection beginning, combustion characteristics, such as, preferably, combustion point, and/or injection quantity are used as the control parameter of a cylinder pressure-based combustion control method.

10. The method according to claim 1, wherein an air-path control method controls an NOx value, wherein a combustion control method of the air-path control method transmits a signal for changing the NOx value if a set point is exceeded.

11. The method according to claim 1, wherein a lambda probe and an NOx probe are referenced for determining measurement values, wherein the measurement values of the NOx probe are classified with respect to priority relative to those of the lambda probe.

12. The method according to claim 4, wherein a comparison of previously set limiting values of an NOx emission of the internal combustion engine are compared with newly calculated limiting values that are determined by means of the method and, if the limiting values deviate from each other, the value is selected that is closet to a limiting value that can be set in advance externally.

13. The method according to claim 1, wherein a combined control of an NOx concentration in the exhaust gas, a combustion air ratio in the exhaust gas, an exhaust gas temperature, a combustion noise, a combustion function, and a cylinder peak pressure is performed.

14. The method according to claim 1, wherein a cascade control method is performed, wherein the NOx control method is used as the outer cascade and the combustion control method is used as the inner cascade.

15. The method according to claim 1, wherein an average pressure, a waste-heat function, and/or a cylinder peak pressure is used as the control parameter of a cylinder pressure-based combustion control method.

16. A control unit of an internal combustion engine, the control unit comprising: a first control means for performing a cylinder pressure-based combustion control method and a second control means for performing an NOx control method, wherein the first and second control means are linked to each other.

17. The control unit according to claim 16, wherein the control unit has a cascade control method made from first and second control means.

18. The control unit according to claim 16, wherein the first control means has a combustion control method and the second control means has an air-efficiency control method that are each connected to an NOx probe and to a lambda probe and a correlation element by means of which a first NOx value from the combustion control method and a second NOx value from the air-efficiency control method are linked to each other.

19. The control unit according to claim 16, wherein an adaptive control method is provided.

20. The control unit according to claim 16, wherein a virtual NOx sensor is provided.
